(19) United States
(12) Patent Application Publication
(10) Pub. No.: US 2003/0075420 A1
(43) Pub. Date: Apr. 24, 2003

(54) Conveyor chains and wheel assemblies used in conveyor chains

(75) Inventor: Donald E. Larkins, Highland, MI (US)

Correspondence Address: Dickinson Wright PLLC, Ste. 800, 1901 L. Street, N.W., Washington, DC, 20036, US

(73) Assignee: Jervis B. Webb Company, Farmington Hills, MI

(21) Appl. No.: 10/245,397

(22) Filed: Sep. 18, 2002

Related U.S. Application Data
(60) Provisional application No. 60/346,213, filed on Oct. 24, 2001.

(51) Int. Cl. B65G 17/38

(52) U.S. Cl. 198/852; 198/838

(57) ABSTRACT

A conveyor chain includes a number of interconnected links. Each link includes a bearingless wheel assembly that has a simple structure and a wheel made of a special wheel material that is suitable for use as a conveyor wheel material in a corrosive environment. The bearingless wheel assembly includes a wheel having a center bore, a hub extending through the center bore of the wheel and having a flange, and a retainer for engaging the hub to secure the wheel between the flange and the retainer.

### CROSS-REFERENCES TO RELATED APPLICATION

This application claims the benefit of U.S. Provisional Application No. 60/346,213, filed Oct. 24, 2001, the entire disclosure of this application being considered part of the disclosure of this application and hereby incorporated by reference.

### FIELD OF THE INVENTION

This invention relates to conveyor chains and wheel assemblies used in conveyor chains.

### BACKGROUND OF THE INVENTION

Conveyor chains are used in a variety of conveyor systems. In a power-and-free conveyor system, for example, a conveyor chain is used as the driving mechanism. A typical power-and-free conveyor system generally includes a power track, a free track, and trolleys capable of traveling along the free track. Usually, two trolleys, a leading trolley and a trailing trolley, support a carrier which in turn supports a load or article being conveyed. Each leading trolley includes a pusher dog which extends towards the power track and which is engageable with a pusher head carried by a moving conveyor chain. When the pusher head and the pusher dog are engaged, the leading trolley (and the carrier) is pushed along the free track by the moving chain. When the pusher dog is retracted, or otherwise disengaged from the pusher head, the trolley stops moving, thus halting the carrier.

The conveyor chain includes a number of chain links and is placed in a conventional power track. To facilitate its movement in the power track, the conveyor chain includes a number of power or load wheels, usually comprised of hardened steel, each of which has a horizontal axis of rotation that is transversely arranged with respect to the direction of the track. The load wheels support the conveyor chain in the vertical direction and allow the conveyor chain to withstand vertical loads. Conventional conveyor chains also commonly include steel guide wheels, each of which has a vertical axis of rotation. The guide wheels may come in contact with the internal side surfaces of the power track and support the conveyor chain in the horizontal direction, allowing the conveyor chain to withstand horizontal loads, such as loads generated by resistance forces when the chain is moving through a horizontally curved section of the track.

Each wheel of the conveyor chain is rotatably mounted to the conveyor chain using a bearing, such as a ball or roller bearing. Although bearings facilitate the movement of the conveyor chain in the power track, the bearings may last only about four to six weeks if the conveyor chain is used in a corrosive environment or if the bearings come in contact with a corrosive material. Many chain driven material handling operations require operation of the chain in such corrosive environments such as when the transported material is passed through a dip tank or washer for cleaning the article prior to painting. Further, in applications where an article is washed in preparation for painting it must also be dried in an oven in order to completely dry the article before it proceeds to the paint booth. The elevated oven temperatures, on the order of 400°-450° Fahrenheit, can distort the dimensions or alter the properties of commonly used wheel assemblies, particularly the bearings. Frequent replacement of the bearings requires frequent shutdowns of the conveyor system, resulting in decreased productivity and additional maintenance time and labor.

### SUMMARY OF THE INVENTION

The present invention overcomes the above-discussed problems associated with the prior art conveyor chains and wheel assemblies.

In accordance with one aspect of the invention, a conveyor chain includes a plurality of interconnected links, at least one of which includes a link frame and a load wheel subassembly. The load wheel subassembly includes a wheel having a center bore and a shallow counter bore on one side. The hub extends through the center bore and has a flange that fits into the counter bore of the wheel and a retainer for engaging the hub to secure the wheel between the flange and the retainer. The wheel is rotatable about the hub without the use of a bearing.

In accordance with still another aspect of the invention, a bearingless guide wheel subassembly for use in a conveyor chain consists of a wheel having a center bore, a hub extending through the center bore of the wheel and having a flange, and a retainer for engaging the hub to secure the wheel between the flange and the retainer. The wheel is rotatable about the hub without the use of a bearing.

In accordance with a further aspect of the invention, a conveyor chain includes a plurality of interconnected links, at least one of which links includes a wheel subassembly. The wheel subassembly includes a wheel of a special wheel material.

In accordance with a still further aspect of the invention, a wheel assembly for use in a conveyor chain includes a wheel of a special wheel material.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is an elevation view of a conveyor chain of the present invention.

FIG. 2 is an enlarged elevation view of the conveyor chain shown in FIG. 1 illustrating a chain link with a guide wheel assembly.

FIG. 3 is an exploded elevational view of the guide wheel assembly shown in FIG. 2.

FIG. 4 is a top view of the conveyor chain shown in FIG. 1 illustrating a chain link with two load wheel assemblies.

FIG. 5 is a side view of the chain link shown in FIG. 4.

FIG. 6 is an exploded top view of the load wheel assembly shown in FIG. 4.

FIG. 7 is a top view of a chain link with a pusher dog and four load wheel assemblies.

FIG. 8 is a side view of the chain link shown in FIG. 7.

### DETAILED DESCRIPTION OF THE PREFERRED EMBODIMENTS

The following description of the presently preferred embodiments of the invention refers to the accompanying drawings. The description and drawings are directed to exemplary embodiments of the invention. However, other embodiments are possible and changes may be made to the embodiments described below without departing from the spirit and scope of the invention. The scope of the invention is defined by the appended claims. The description and drawings are merely illustrative, not limiting.

In general, the following description discloses several embodiments of a bearingless wheel assembly. As used herein, a bearing is a friction reducing component disposed between the wheel and axle or hub and that includes a rolling element and/or utilizes rolling contact, such as a ball or roller bearing. The term “bearingless” means “without a bearing that includes a rolling element and/or utilizes rolling contact.” As is described in greater detail below, the respective wheel assembly embodiments each include low friction and self-lubricating interaction between the wheel and hub and manufactured gaps between the wheel and other components to provide a bearingless wheel assembly that is a significant advancement with respect to use of a chain in harsh environments.

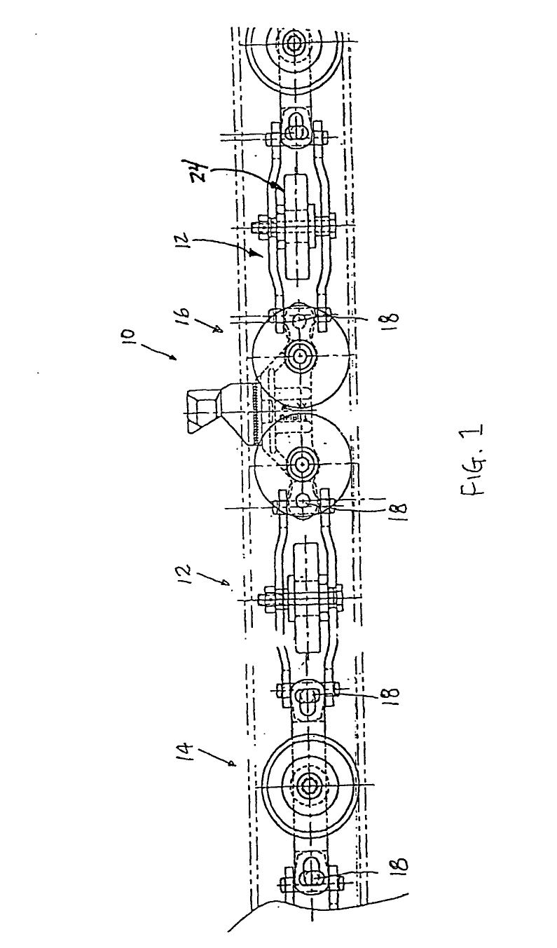

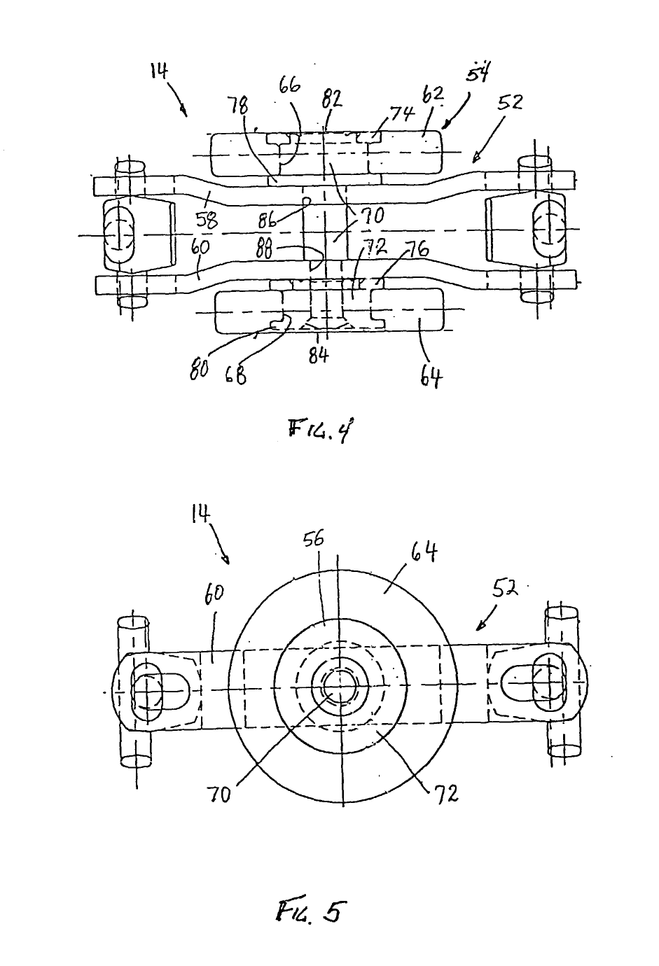

With the above general description of the invention in mind, the specific guide wheel assembly 24, load wheel assembly 54, and load wheel subassembly 96, shown in FIGS. 1-3, FIGS. 4-6, and FIGS. 7-8, respectively, will now be described.

FIG. 1 illustrates a conveyor chain 10 that includes a number of interconnected links 12, 14, 16. The links 12, 14, 16 may be pivotably connected with one another in any conventional manner, such as by the use of a chain pin 18 as shown FIG. 1. Preferably, any two interconnected links may pivot about each other vertically or horizontally, or in both directions.

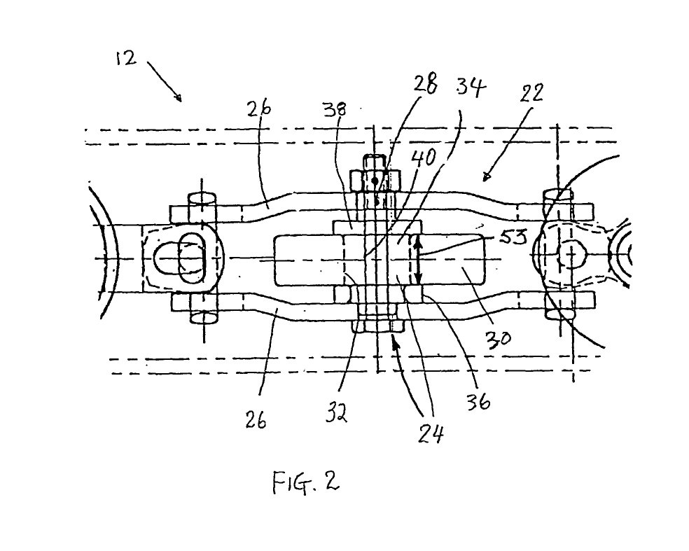

The links of the conveyor chain may be of different types. For example, as illustrated in FIG. 2, the chain link 12 may include a link frame 22 and a guide wheel assembly 24 mounted to the link frame 22. The link frame 22 preferably includes two side links 26, which are vertically arranged with respect to one another. Alternatively, the link frame may be of any suitable type, such as any of the link frames that are currently in use in the conveyor industry.

The guide wheel assembly 24 in conveyor link 12 is designed to engage the inner side surfaces of the power track, thus providing support to the conveyor chain 10 in the horizontal direction. In general, a guide wheel assembly, as defined herein, has a substantially vertical axis of rotation and is designed to provide support to the conveyor chain in the horizontal direction. The guide wheel assembly 24 of FIG. 2 is shown in greater detail in FIG. 3 to include a wheel 30 having a center bore 32, an axle 34, and a retainer 36 for securing the wheel 30 to the axle 34. In a preferred embodiment, the guide wheel assembly 24 may include only the three components: the wheel 30, the axle 34 and the retainer 36, although other embodiments may include additional components. The axle 34 includes a flange 38, a mounting nib 45 for engaging the side link 26, and a stepped sleeve 39 defining a first segment or hub 41, a second segment 43, and a third segment 55 for engaging the other side link 26 (FIG. 3). As is illustrated in FIG. 2, the hub 41 of the axle 34 is disposed within the center bore 32 of the wheel 30 which is in turn retained between the flange 38 and the retainer 36. Although the retainer 36 may be mounted to the axle 34 in any suitable manner, including the illustrated threaded bolt 28 and nut 29, the retainer 36 is preferably disposed about the third segment 55 and swaged onto the axle 34. The retainer 36 preferably includes a chamfer 57 to receive the excess metal of axle 34 when they are swaged together to create the three piece guide wheel assembly including the axle 34, wheel 30, and retainer 36.

The wheel 30 preferably is mounted to rotate relative to the axle 34. The axle 34 (and/or the retainer 36) preferably is fixed relative to the link frame 22 with the bolt 28 and nut 29 in any suitable manner. In the embodiment shown in FIGS. 2 and 3, the retainer 36 (thus the axle 34) is fixed to the link frame 22 such as by compressing the retainer 36 against one of the side links 26 by tightening the nut 29 or other suitable means generally known in the art.

The inner diameter 48 of the wheel center bore 32 and the outer diameter 46 of the axle hub 41 are controlled during manufacture to provide a gap therebetween thus allowing the wheel 30 to rotate about the axle 34 without substantial interference. In a preferred embodiment, the inner wheel diameter 48 is greater than the hub diameter 46 by a magnitude of between about 0.006 and about 0.012 inch, and is preferably 0.009 inch, although a diameter difference outside of this range may be suitable for other embodiments. A similar gap is maintained on the sides of the wheel 30. That is, the width 50 between the side surfaces 51 of the wheel 30 (FIG. 3) is preferably within a range of about 0.006 and about 0.012 inch, and preferably 0.009 inch, less than the distance 53 between the flange 38 and the retainer 36 (FIG. 2). The resulting gap allows the wheel 30 to rotate without substantial interference from the flange 38 and retainer 36.

In the illustrated embodiment, when the wheel 30 rotates about the axle 34, the inner surface of the wheel 30 is permitted to directly engage the outer surface of the hub 41. The configuration and material compositions of the guide wheel assembly, particularly the wheel 30 and axle 34, eliminate the need for a bearing. Accordingly, in the preferred embodiment, when the wheel 30 rotates about the axle 34, there is a rotationally sliding contact between the inner surface of the wheel 30 and the outer circumferential surface of the hub 41.

The axle 34, and particularly the hub 41 thereof, may be specially treated or coated to reduce the frictional forces between the wheel 30 and the hub 41. For example, the axle 34 is preferably comprised of heat-treated steel, such as Rockwell “C” 22-30. Additionally or alternatively, a nitrotec solution may be applied to the surface of the axle 34. The axle 34 may also be treated in other manners generally known in the art to increase its resistance to corrosion and resistance to wear. The retainer 36 may also be similarly treated or coated.

The guide wheel assembly 24 preferably is substantially vertically arranged and positioned between the side links 26 of the link frame 22, with third axle segment 55 extending at least part way through the center orifice of side link 26 and the mounting nib 45 of axle 34 extending at least part way through the center orifice of the other side link 26. Alternatively, the wheel assembly may not be positioned between the two sidebars and may be connected to only one of the side links or any other portion of the link frame. The guide wheel assembly 24 is mounted to the link frame 22 using the bolt 28 and the nut 29 so that the bolt 28, nut 29, and axle 34 do not rotate relative to the link frame. The bolt 28 extends through an orifice on one side link 26, through the hollow center 40 of the axle 34, and an orifice on the other side link 26. The guide wheel subassembly 24 is preferably assembled in the conveyor chain 10 with every other pitch being inverted, but the nut 29 is preferably always on the open side of the track. This allows for the maximum wear surfaces on the inside sides of the track with the guide wheel 30.

In the present invention, the guide wheel 30 is made of an engineered plastic (preferably injection moldable) that, due to its performance characteristics, is particularly suitable for use as a wheel material, even in corrosive environments. Of particular importance are the mechanical properties of the wheel material. However, in certain applications, thermal, electrical, and/or chemical properties may also dictate material selection. As to the mechanical properties, the coefficient of friction of the engineered plastic allows the wheel 30 to rotate about the hub without the use of a bearing. A material having a coefficient of friction of less than about 0.25, and more preferably on the order of about 0.21 or less, are particularly suitable. Another important mechanical criteria is the wearability of the wheel material. Wearability is commonly quantified through the use of a wear factor according to ASTM PTM 55010 measured in units of in³-min/ft-lbs-hr. Wear factors of greater than about 85×10⁻¹⁰ are generally suitable for the present invention. Even more preferably, the wear factor approaches or exceeds 100×10⁻¹⁰.

While a variety of fiber reinforced and unreinforced engineered plastics may be suitable for use in the present invention, a fiber reinforced engineered plastic, specifically a fiber reinforced polyetherketone, is preferred. One example of this type of special wheel material is the fiber reinforced polyetherketone available from Victrex USA Inc. and referred to as Ketron® PEEK HPV 150CA30. Other engineered plastics available from Victrex that are suitable for use with the invention include the Techtron® HPV and Ketron® PEEK 1000. The fiber reinforcement of the preferred material includes on the order of about 30% carbon fiber reinforcement to provide additional strength, durability, wearability, and stability at elevated temperatures. The material also preferably includes graphite and PTFE lubricant additives to enhance the self-lubrication and low friction performance.

As noted above, thermal and chemical characteristics of the engineered plastic may also be important in selecting a suitable material for particular applications. The geometric stability of the wheel is important in maintaining the desired gaps between the wheel and the hub, as well as between the wheel and the flange and retainer, during operation. Accordingly, where the invention is subjected to extreme temperatures, a material with a limited coefficient of thermal expansion, such as but not limited to less than about 3.5×10⁻⁵ inch/inch/° F., is preferred. Similarly, where the invention is subjected to chemicals, the chemical characteristics (including water absorption and resistance to harsh materials such as acid, alkalines, chlorines, and the like) should be considered. Again, the properties of the Victrex Ketron® PEEK HPV 150CA30 are generally suitable for most applications. One skilled in the art, when presented with application specific criteria should select a material that is suitable for the environments and conditions to which the wheel will be subjected. Notwithstanding the specific description of material properties and preferred materials provided herein, those skilled in the art will appreciate that other materials having physical or chemical characteristics similar to the materials or characteristics described herein may be suitable for use as a wheel material in the present invention. For purposes of this patent, the phrase “special wheel material” includes any one of the materials described above as well as other materials having similar physical and/or chemical characteristics. Further, while the wheels are described herein as being comprised entirely of the special wheel material, those skilled in the art will appreciate that the wheel may be a composite of different materials bonded or coupled to one another and with the special wheel material positioned at the inner wheel diameter.

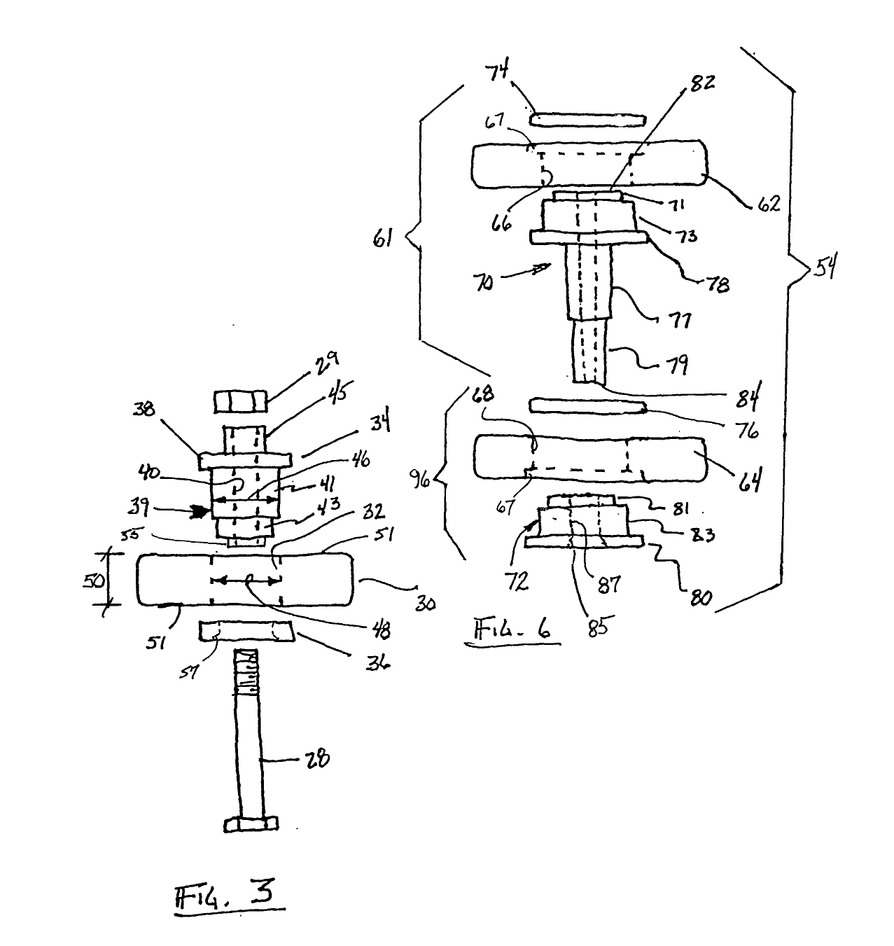

FIGS. 4-6 illustrate another type of chain link 14 having a bearingless wheel assembly. The chain link 14 includes a link frame 52 and a load wheel assembly 54 mounted to the link frame 52. The link frame 52 preferably includes two side links 58, 60, which are horizontally arranged with respect to one another. Alternatively, the link frame 52 may be a frame of any suitable type, such as any of the link frames that are currently in use in the conveyor industry.

The load wheel assembly 54 is designed to engage the top and bottom inner surfaces of the power track, thus providing support to the conveyor chain in the vertical direction. In general, a load wheel assembly, as defined herein, may be a wheel assembly that is designed to provide support to the conveyor chain in the vertical direction and that has a substantially horizontal axis of rotation that is transverse to the direction of the track. The load wheel assembly 54 generally includes an axle subassembly 61 and a load wheel subassembly 96. As is best illustrated in FIG. 6, the axle subassembly 61 includes a load wheel 62 having a center bore 66, a shallow counter bore 67, an axle 70, and a retainer 74 for securing the wheel 62 to axle 70. The axle 70 is generally cylindrical in configuration having a retainer seat 71, a first hub 73, a flange 78, a side link segment 77, a side link positioning shoulder 75, and a hub seat 79. The load wheel subassembly 96 includes a wheel 64, a second axle 72, and a retainer 76. The wheel 64 includes a center bore 66 with a shallow counter bore 67 and the second axle 72 includes a retainer seat 81, a wheel support hub 83, a flange 80, and a passage 87 extending therethrough and sized to receive the hub seat 79 of the axle 70. The retainers 74, 76 engage the respective axles 70 and 72 to retain the wheels 62 and 64 between the retainers and the respective flanges 78 and 80. Notwithstanding this representative configuration, those skilled in the art will appreciate that the wheels 62 and 64 may be secured to differently configured axles or hubs by other suitable means without departing from the scope of the invention as defined by the appended claims. The retainers 74 and 76 are preferably swaged onto the axles 70 and 72 or may be attached to the axles 70 and 72 through other suitable means. In a preferred embodiment, each load wheel assembly includes only the following three components: the wheels 62 and 64, the axles 70 and 72, and the retainers 74, 76, although variations of the disclosed embodiment may include additional components.

The load wheels 62, 64 preferably are rotatably mounted to the respective axles 70 and 72, which are fixed to side links 58 and 60 of the link frame 52. A suitable diameter difference is maintained between the inner diameter of each wheel 62, 64 and the outer diameter of the corresponding hubs 73 and 83 allowing the wheels 62, 64 to rotate about the axles 70 and 72 without substantial interference. Just as with the guide wheel assembly 24, the difference preferably varies between about 0.006 and about 0.012 inch, although it may be outside of this range in other embodiments. Similarly, a gap of about 0.006 and about 0.012 inch is maintained between the width of the wheels 62, 64 and the spacing of the retainers 74, 76 and the flanges 78, 80 to allow the wheel 62, 64 to rotate without substantial interference from the flange 78, 80 and retainer 74, 76. The relevant width of the wheels may be based upon the distance between the side surfaces of the wheels as shown in FIGS. 2 and 3 or, alternatively, the distance between the shallow counterbore 67 and the opposite wheel side surface as shown in FIGS. 4 and 6. When each wheel 62, 64 rotates about the corresponding axles 70 or 72, the wheel surfaces defining the center bores 66 and 68 are permitted to directly engage the outer surface of the hubs 73 and 83. Again, the configuration and material compositions of the wheel assembly, particularly the wheels 62, 64 and axles 70 and 72 eliminate the need for a bearing. Accordingly, in the preferred embodiment, when each wheel 62, 64 rotates about the corresponding axle 70 or 72, there is a rotational sliding contact between the inner surface of the wheel 62, 64 and the outer surface of the corresponding hubs 73 and 83.

When the load wheel assembly 54 is mounted to the link frame 52, the stepped side link segment 77 of the axle 70 preferably extends through a large bore 86 on the side link 58 and the second hub seat 79 is disposed within a small bore 88 on the side link 60. The first and second ends 82, 84 of the axle 70 extend beyond the link frame 52. Preferably, the axle 70 is affixed to the link frame 52 via side link 60. The first and second load wheels 62, 64 are positioned outside the two sides of the link frame 52, and are swaged together with the displaced metal at end 84 of axle 70 being received in the chamfer 85 of second axle 72. Accordingly, in this preferred embodiment, the load wheel assembly 54 and link frame 52 form chain link 14.

Preferably, each load wheel 62, 64 is made of the same type of wheel material described in connection with the guide wheel, although it may be made of any other suitable material. Also, the axles 70 and 72 are preferably comprised of a heat-treated steel and may be treated or coated to reduce the coefficient of friction between the wheels and hubs and to increase its resistance to corrosion and wear.

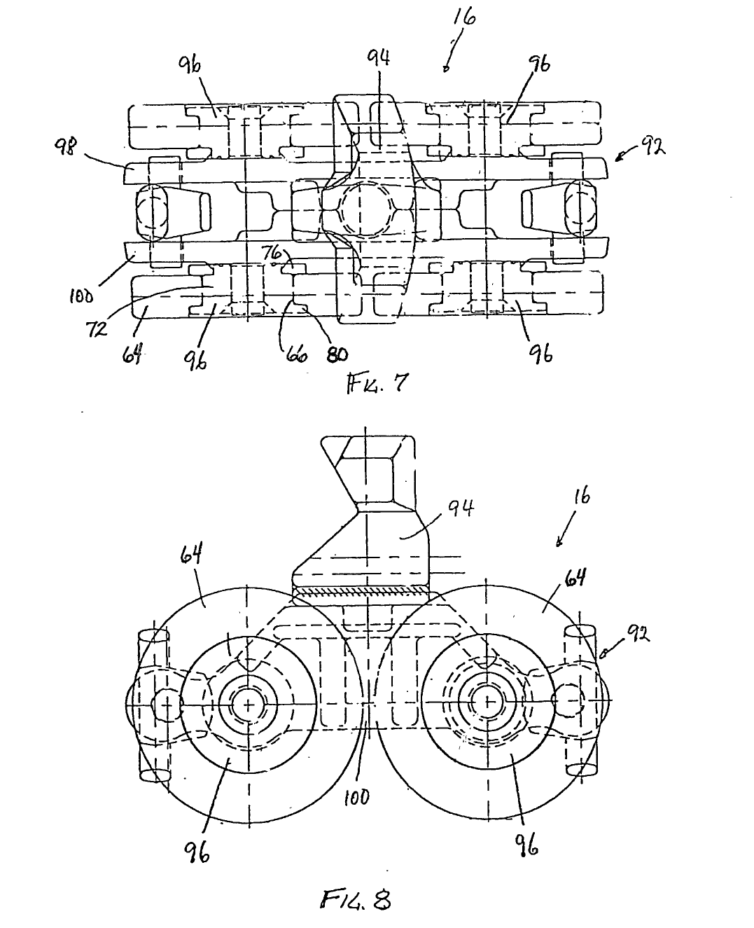

FIGS. 7 and 8 illustrate another type of chain link 16 that functions as a pusher bracket. The chain link 16 may include a link frame 92, a pusher head 94, and four load wheel subassemblies 96, each of which is mounted to the link frame 92. The link frame 92 preferably includes two sidebars 98 and 100, which are horizontally arranged with respect to one another and welded together. Alternatively, the link frame may be a frame of any suitable type, such as any of the link frames that are currently in use in the conveyor industry.

As described in the Background section, the pusher head 94 is engageable with the pusher dog of a conveyor carrier chain to move the carrier chain along the conveyor track. In this embodiment, a portion of the pusher head 94 is positioned between, and secured to, the sidebars 98, 100 of the link frame 92. Alternatively, the pusher dog may be mounted to the link frame in any suitable position and manner.

The chain link 16 shown in FIGS. 7 and 8 includes four load wheel subassemblies 96 to ensure that the chain link 16 is properly positioned and oriented in the power track and to give the chain link 16 the capacity to withstand greater vertical forces than the type of chain link shown in FIGS. 4-6. One reason for the increased load capacity is that the pusher head 94 is subjected to substantial forces when it is engaged with a pusher dog of the carrier chain. Preferably, two load wheel subassemblies 96 are placed on each side of the link frame 92. In general, however, a chain link of this type may include any number of load wheel assemblies, and the wheel assemblies may be arranged in a variety of manners.

Each of the load wheel subassemblies 96 shown in FIGS. 7 and 8 are substantially the same as the subassemblies described with reference to FIG. 6 and generally include a wheel 64 having a center bore 66 and shallow counterbore 67, a generally cylindrical axle 72 extending through the center bore 67, and a retainer 76 for coupling the wheel 64 to the axle 72. The axle 72 again includes a retainer seat 81, a wheel support hub 83, a flange 80, and a passage 87. In a preferred embodiment, each load wheel subassembly 96 may include only the three components: the wheel 64, the axle 72 and the retainer 76, although it may include additional components. In each of the load wheel subassemblies 96 shown in FIGS. 7 and 8, the retainer 76 is fixed to the axle 72 with the wheel 64 positioned between the flange 80 and the retainer 76. Preferably, the retainer 76 is swaged onto the axle 72, or it may be attached to the axle in any suitable manner.

Each load wheel 64 is rotatable relative to the corresponding support hub 83, which is fixed to the link frame 92. Just as with the above described embodiments, a suitable gap is maintained between the inner diameter of each wheel 64 and the outer diameter of the corresponding hub 83, allowing the wheel 64 to rotate about the hub 83 without substantial interference. In a preferred embodiment, the gap may vary between about 0.006 and about 0.012 inch, although it may be outside of this range in other embodiments. Similarly, a gap is maintained on the sides of each wheel 64, to allow the wheel 64 to rotate without substantial interference from the flange 80 and retainer 76. When each wheel 64 rotates about the corresponding hub 83, there is a rotationally sliding contact between the inner surface of the wheel 64 and the outer surface of the corresponding hub 83.

Preferably, each load wheel 64 is made of the same type of wheel material described in connection with the guide wheel. However, the load wheel 64 may be made of any other suitable special wheel material. Also, portions of each axle 72 are preferably comprised of a heat-treated steel and may be treated or coated to reduce the coefficient of friction between the wheels and hubs and to increase its resistance to corrosion and wear.

The conveyor chain 10 shown in FIG. 1 includes only the three types of interconnected chain links 12, 14, 16 with a guide link 12 positioned between alternating load links 14 and pusher links 16. That is, in the preferred chain configuration, each guide link 12 with a guide wheel assembly 24 is connected to a load link 14 with a load wheel assembly 54 and a pusher link 16 with a plurality of load wheel subassemblies 96. Thus, the pusher links 16 can be alternately arranged or arranged in configurations to create different center distances between pusher brackets 94. In general, however, a conveyor chain of the present invention may include any number of different types of chain links, which can be arranged in any suitable manner.

The present invention has a number of advantages over the prior art. For example, the wheel assemblies of the present invention last longer in a corrosive environment, because they do not use any bushings, ball or roller bearings. In addition, the wheel assemblies of the present invention are simple and economical to make, assemble, install and use. Further, the wheels, when made of a special wheel material, provides low-friction and exceptional resistance to heat, wear, and/or corrosion. As a result, in comparison with the prior art conveyor chains, the power required to move the conveyor chain in the power track is reduced and the life of the conveyor chain is increased.

1. A conveyor chain comprising:
a plurality of interconnected links including a first link having:
a link frame; and
a wheel assembly including
a wheel having a center bore,
an axle extending through the center bore of the wheel and fixed relative to the link frame, the axle having a hub and a flange, wherein the wheel is rotatable about the hub without the use of a bearing, and
a retainer fixed to the axle and retaining the wheel between the flange and the retainer.

2. The conveyor chain of claim 1, wherein the wheel assembly is a guide wheel assembly having a vertical axis of rotation.

3. The conveyor chain of claim 1, wherein the hub has a first diameter, wherein said center bore has a second diameter in the range of about 0.006 inch to about 0.012 inch greater than said first diameter.

4. The conveyor chain of claim 3 wherein said hub has a first end integral with said flange, wherein said wheel has a width, and wherein said retainer is spaced from said flange a distance about 0.006 to about 0.012 inch greater than said wheel width.

5. The conveyor chain of claim 1, wherein a surface of the hub contacts the wheel during operation, said surface having a friction reducing coating.

6. The conveyor chain of claim 5, wherein said friction reducing coating is a nitrotec solution.

7. The conveyor chain of claim 2, further including a second link having a load wheel assembly with
first and second wheels each having a center bore,
a first axle having a first end and a second end, a first hub proximate said first end, a flange integral with said first hub, and a hub seat proximate said second end, said first hub being disposed in said center bore of said first wheel,
a second axle having a passage extending therethrough and a second hub, said second hub being disposed in said center bore of said second wheel,
a first retainer fixed to the first hub and retaining the first wheel between the flange of the first axle and the first retainer, and
a second retainer fixed to the second axle and retaining the second wheel between the flange of the second axle and the second retainer.

8. The conveyor chain of claim 1, wherein the wheel is made of a special wheel material.

9. The conveyor chain of claim 8, wherein the special wheel material is a polyetherketone.

10. The conveyor chain of claim 8, wherein the coefficient of friction between the wheel and the hub is about 0.21.

11. A bearingless wheel assembly for use in a conveyor chain, the wheel assembly consisting of
a wheel having a center bore,
an axle extending through the center bore of the wheel, the axle including a hub and a flange, wherein the wheel is rotatable about the hub without the use of a bearing, and
a retainer secured to the axle to couple the wheel between the flange and the retainer.

12. A conveyor chain comprising a plurality of interconnected links, at least one of the links including a wheel assembly, wherein the wheel assembly includes a wheel made of a special wheel material.

13. The conveyor chain of claim 12, wherein the special wheel material is a polyetherketone.

14. The conveyor chain of claim 13, wherein the special wheel material is a carbon fiber reinforced polyetherketone.

15. The conveyor chain of claim 14, wherein the special wheel material comprises about 30% carbon fiber.

16. The conveyor chain of claim 12, wherein the special wheel material is reinforced with carbon fiber.

17. The conveyor chain of claim 12 wherein said plurality of interconnected links includes a first link having a link frame, wherein the wheel has a center bore, and wherein the wheel assembly further includes
an axle extending through the center bore of the wheel and fixed to the link frame, the axle having a hub and a flange, wherein the wheel is rotatable about the hub without the use of a bearing, and
a retainer fixed to the axle and retaining the wheel between the flange and the retainer.

18. The conveyor chain of claim 12, wherein the plurality of interconnected links includes a link having a load wheel assembly with first and second wheels each having a center bore,
a first axle having a first end and a second end, a first hub proximate said first end, a flange integral with said first hub, and a hub seat proximate said second end, said first hub is disposed in said center bore of said first wheel,
a second axle having a passage extending therethrough and a second hub, said second hub being disposed in said center bore of said second wheel,
a first retainer fixed to the first axle and retaining the first wheel between the flange of the first axle and the first retainer, and
a second retainer fixed to the second axle and retaining the second wheel between the flange of the second axle and the second retainer.

19. A wheel assembly for use in a conveyor chain, the wheel assembly including a wheel of a special wheel material.

20. The wheel assembly of claim 19, wherein the special wheel material is a polyetherketone.

21. The wheel assembly of claim 20, wherein the special wheel material is a carbon fiber reinforced polyetherketone.

22. The wheel assembly of claim 21, wherein the special wheel material comprises about 30% carbon fiber.

23. The wheel assembly of claim 19, wherein the special wheel material is reinforced with carbon fiber.
